(19) United States
(12) Patent Application Publication
(10) Pub. No.: US 2003/0183464 A1
(43) Pub. Date: Oct. 2, 2003

(54) Automatic slack adjuster for hydraulic brake

(76) Inventors: Yen-Chieh Mao, Kaohsiung (TW); Ching-Huan Tseng, Hsinchu (TW)

Correspondence Address: BAKER & BOTTS, 30 ROCKEFELLER PLAZA, NEW YORK, NY, 10112

(21) Appl. No.: 10/147,059

(22) Filed: May 16, 2002

(30) Foreign Application Priority Data
Apr. 2, 2002 (TW) 91106665

(51) Int. Cl. F16D 65/38

(52) U.S. Cl. 188/196 P

(57) ABSTRACT

A slack adjuster with the capability of self-adjusting the position of the piston in the caliper within the predefined range is described. The slack adjuster has a cylinder, a piston and a resilient body. Due to the friction and resilience among the piston, the resilient body and shafts, the piston of the brake member can controllably drawn back into the cylinder according to a predetermined force to reduce vibration, noise and abrasion of a friction pad when the brake member is idle. The pull of the piston is allowed to be automatic adjusted into a balance position so that the distance between the friction pad and the disc is maintained in a predetermined range.

### FIELD OF THE INVENTION

The present invention generally relates to a slack adjuster, and more particularly, to a slack adjuster with self-adjusting capability to maintain the position of the piston of the caliper within the predefined range in a hydraulic brake system of a bicycle.

### BACKGROUND OF THE INVENTION

It is well known that a braking force generated from a friction pad of a rim brake system is used to halt a bicycle by clipping both wheel edges of the bicycle. However, the dust and moisture are easily accumulated on the surfaces of the wheel edges. Such a situation particularly occurs when the bicycle is ridden in a roadway covered with the mud or water. Therefore, operating circumstances of the friction pad go from bad to worse, resulting in many problems such as a brake performance reduction, or even the safety issues. Moreover, the cable is applied to transfer the braking force to the brake device at the wheel side. Since the cable will tend to be extended when the applied tension is too large when the braking lever is extremely pressed, the braking device will not give enough braking force in this situation.

To solve the problems, a disc brake system 100 currently has been developed, as shown in FIG. 1. Braking fluid and pipelines are used as the medium to transmit the brake force in a braking system. When the rider pulls a drag bar of the braking system with a force 102, a single piston 104 in the braking system pushes the braking fluid through a guide tube 106. The braking fluid is injected into a brake member 108 of the braking system to pull out the friction pad 112 to impel a piston 110 against a disc 114 of the brake member 108.

To obtain an enough force ratio of disc brake system 100, the cross-sectional area of the piston 110 of the disc brake system 100 is lower-than-normal. Therefore, the incoming and outgoing of the braking fluid is insufficient so that the friction pad 112 of the disc brake system 100 cannot be far away from the disc 114 after the braking process is finished. As a result, the friction pad 112 is incapable of completely separating from the disc 114, consuming most of the applied force of the rider, making a loud noise and shock of the braking system 100 and making a abrasion of the friction pad 112 during a normal riding. Further, if the heat of the abrasion of the friction pad 112 is unable to be transmitted, a poor performance and danger of the bicycle occur.

However, since the cross-sectional area of the piston 110 of the disc brake system 100 is lower-than-normal, the friction pad 112 cannot excessively separate from the disc 114 when the friction pad 112 in a balance position is idle. Due to the lack of the incoming and outgoing of the braking fluid, the friction pad excessively separated from the disc is incapable of moving toward the disc 114 and of contacting tightly the disc in a stroke.

It is necessary to develop an adjustable abrasion clearance since the friction pad 112 cannot separate from the disc 114. Traditionally, a screw 116 and a ratchet are applied to adjust the position of the piston 110 and the friction pad 112 corresponding to the disc 114. However, the position adjustment must usually be adjusted. Further, a proper position of the friction pad 112 cannot be obtained, even resulting in danger during a riding.

Consequently, after accomplishing the braking process, how to separate the brake disc and the friction pad for a proper clearance is an important problem. Moreover, as the friction pad is gradually worn down, how to make the braking system self-adjust the gap between the friction pad and the disc to maintain the clearance deviation of the friction pad for bicycle manufacturers to increase the rapid and precise brake effect of the brake system are also current significant issues.

### SUMMARY OF THE INVENTION

The primary object of the present invention is that a slack adjuster is used to self-adjust the piston of the braking system to an appropriate position after a braking process is completed to solve problems of noise, shock, abrasion and heat accumulation.

Another object of the present invention is that the slack adjuster is used to self-adjust automatically a predetermined clearance between the piston and the friction pad after the friction pad is worn down to solve a problem of manual adjustment of the piston position.

According to the above objects, the present invention sets forth an automatic slack adjuster with three embodiments to explain the spirit of the present invention.

In first embodiment, the slack adjuster comprises a cylinder, a piston and a resilient body. The cylinder comprises a cavity which includes a rod along an axial center. The surface region of the cavity includes at least one protruding portion to control an elongation or compression deformation of the resilient body along the axial center. Additionally, the piston along the axial center has a friction pad to stop a disc of the braking system.

The first end portion of the resilient body is mounted on the rod of the cylinder and the second end portion of the resilient body resists against the sidewall of the piston due to friction. The end portion of the rod has a flange opposed against the first end portion of the resilient body. A pin inserted into the end portion of the rod is also used to substitute for the flange. The resilient body contacts the protruding portion of the cylinder to control the elongation or compression along the axial center.

When starting to brake, the fluid pressure within the cylinder is increased to move the piston toward the disc of the braking system so that the resilient body experiences a restoring force due to compression. When the braking process is finished, the piston moves away from the disc. If the thickness of the friction pad is constant, because a restoring force of the resilient body is smaller than the friction force between the second portion of the resilient body and the sidewall of the piston, the resilient body can move together with the piston. The resilient body is kept in the first balance position to ensure the clearance between the piston and the disc to be a predetermined value after the piston moves backward.

If the friction pad has been worn down, the friction force between the second end portion of the resilient body cannot overcome the restoring force of the resilient body. Therefore, a relative movement between the resilient body and the piston occurs so that the resilient body slides from the first balance position to the second balance position. After the braking process is finished, the resilient body positioned in the second balance position removes away from the disc. Since the contact between the resilient body and the piston is changed such that a clearance between the piston and the disc is in a predetermined position.

In second embodiment, the slack adjuster comprises a cylinder, a piston, an expansion ring, and a resilient body. The cylinder has a first cavity which includes a rod along an axial center. The piston has a first sidewall coupled with first cavity of cylinder so that the piston reciprocates in the first cavity, and the piston has a second cavity to receive the expansion ring.

The expansion ring has a second sidewall coupled with the second cavity of piston by a friction force, and a flange is positioned at an end portion of expansion ring. The resilient body is coupled with the rod of cylinder. The resilient body has a first portion and a second portion wherein the first portion is mounted on the rod of the cylinder and the second portion resists the flange of expansion ring.

If the friction pad has not been worn down, the friction force between the second sidewall of the expansion ring and the piston is overcome by the restoring force of the resilient body to move the resilient body together with the piston. The expansion ring is always kept in the first balance position. As a result, the clearance between the piston and the disc is same as the predetermined value after the piston moves backward.

If the friction pad has worn down, the friction force between the second sidewall of the expansion ring and the piston cannot overcome the restoring force of the resilient body. Therefore, a relative movement between the resilient body and the piston occurs so that the expansion ring slides from the first balance position to the second balance position. After the braking process is finished, the resilient body positioned in the second balance position can remove the expansion ring and the piston from the disc. Since the contact between the expansion ring and the piston is changed such that a clearance between the piston and the disc is in a predetermined position.

In third embodiment, the slack adjuster comprises a cylinder, a piston, an expansion ring, a shrinkage ring, and a resilient body. The cylinder has a first cavity which includes a rod along an axial center. The piston has a first sidewall coupled with the first cavity of the cylinder so that the piston reciprocates in the first cavity, and the piston has a second cavity to receive the expansion ring and to hold the shrinkage ring and the resilient body.

The expansion ring has a second sidewall for mounting on the second cavity of the piston. A first flange is positioned at a first end portion of the expansion ring. The shrinkage ring has a third sidewall, the third sidewall slides on the rod of the cylinder, and a second flange is positioned at a second end portion of the shrinkage ring. The resilient body is coupled with the rod of the cylinder, and the resilient body is confined between the first flange of the expansion ring and the second flange of the shrinkage ring along the axial center.

If the friction pad has not been worn down, the friction force between the shrinkage ring and the rod of the cylinder is overcome by the restoring force of the resilient body to move the resilient body together with the piston. The shrinkage ring always is kept in the first balance position. As a result, the clearance between the piston and the disc is same as the predetermined value after the piston moves backward.

If the friction pad has worn down, the friction force between the second sidewall of the expansion ring and the piston cannot overcome the restoring force of the resilient body. Therefore, a relative movement between the shrinkage ring and the piston occurs so that the shrinkage ring slides from the first balance position to the second balance position. After the braking process is finished, the shrinkage ring positioned in the second balance position can remove the shrinkage ring and the rod from the disc. Since the contact between the shrinkage ring and the rod is changed such that a clearance between the piston and the disc is in a predetermined position.

In summary, the slack adjuster uses a friction force among a piston, a resilient body, and a cylinder to self-adjust automatically the piston of the braking system to an appropriate position after a braking process is completed. The appropriate position between the friction pad and the disc is located in a predetermined range. More significantly, the slack adjuster is able to self-adjust a balance position of the piston to always acquire a predetermined clearance between a friction pad and a piston when the piston has been worn down due to a frictional motion.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a slack adjuster of a bicycle according to the prior art;

FIG. 2A illustrates a decomposed cross-sectional view of a slack adjuster of first embodiment according to the present invention;

FIGS. 2B-2E illustrate a schematic cross-sectional view of a slack adjuster of first embodiment operation according to the present invention;

FIG. 3A illustrates a decomposed cross-sectional view of a slack adjuster of second embodiment according to the present invention;

FIGS. 3B-3E illustrate a schematic cross-sectional view of a slack adjuster of second embodiment operation according to the present invention;

FIG. 4A illustrates a decomposed cross-sectional view of a slack adjuster of third embodiment according to the present invention; and

FIGS. 4B-4E illustrate a schematic cross-sectional view of a slack adjuster of third embodiment operation according to the present invention.

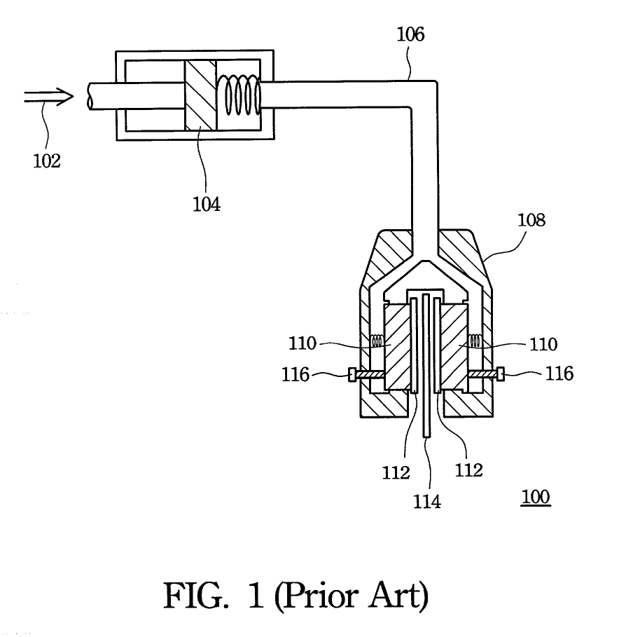

### DETAILED DESCRIPTION OF THE PREFERRED EMBODIMENT

The present invention is directed to a slack adjuster for self-adjusting a position to improve the shortcomings of a braking system applied to bicycles in the prior art. A friction force between a piston, a resilient body, and a cylinder is used to control a braking system so that the piston is allowed to withdraw back to obtain an appropriate or a balance position after braking process is completed. More significantly, the slack adjuster is able to self-adjust a balance position of the piston to acquire a predetermined clearance between a friction pad and the piston when an end portion of the piston has been worn down due to a frictional motion. The slack adjuster of the present invention is also used in a variety of braking system of vehicles. Three embodiments of the present invention are shown as follows.

First Embodiment

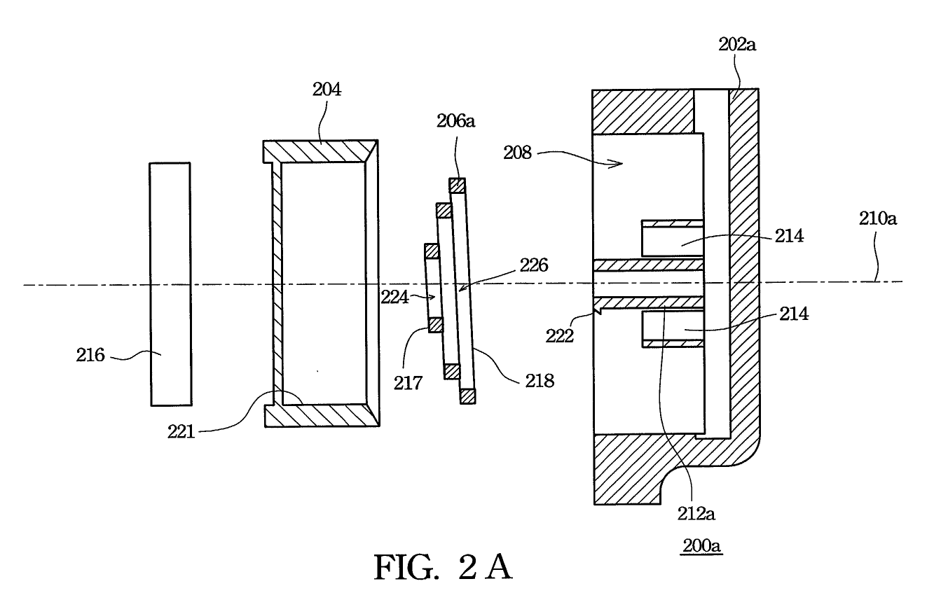

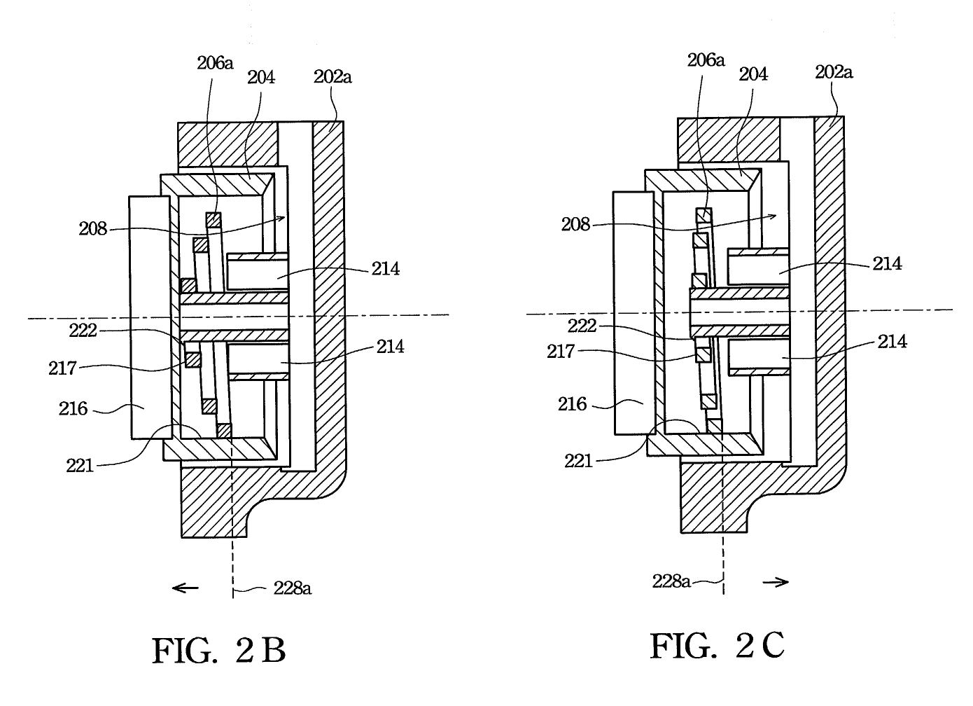

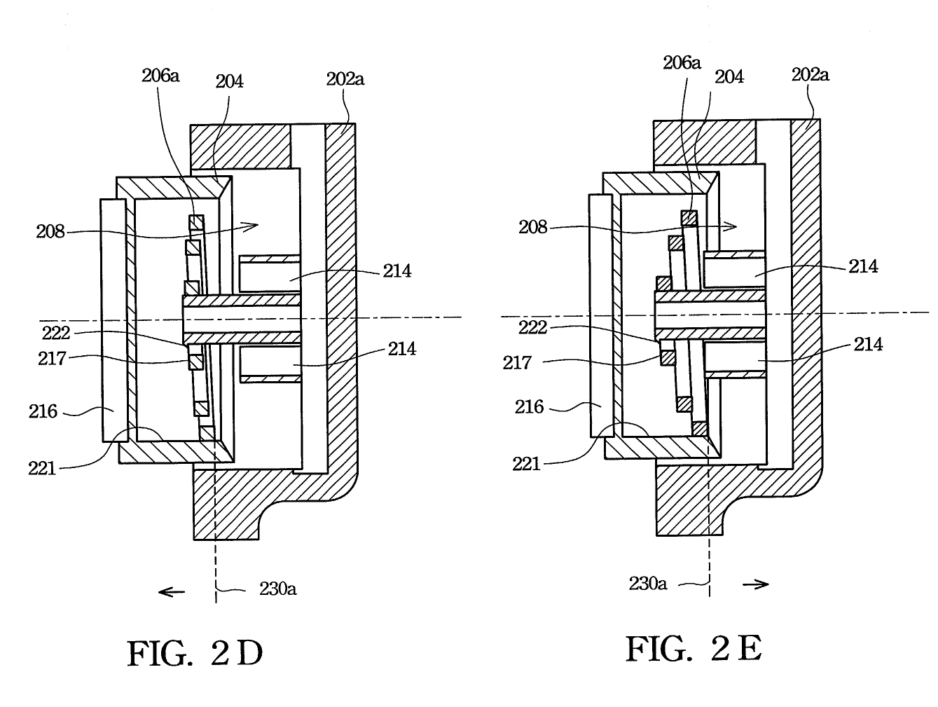

FIG. 2A shows a decomposed cross-sectional view of a slack adjuster 200a of first embodiment according to the present invention. The slack adjuster 200a comprises a cylinder 202a, a piston 204 and a resilient body 206a. The cylinder 202a comprises a cavity 208 which includes a rod along an axial center 210a. The surface region of the cavity 208 includes at least one protruding portion 214, and preferably four protruding portions, to control an elongation or compression deformation of the resilient body 206a along the axial center 210a. Additionally, the piston 204 along the axial center 210a has a friction pad 216 to clip a disc of the braking system.

The first end portion 217 of the resilient body 206a is mounted on the rod 212a of the cylinder 204 and the second end portion 218 of the resilient body 206a resists the sidewall 221 of the piston 204 due to a friction. The end portion of the rod 212a has a flange 222 opposed to the first end portion 217 of the resilient body 206a. A pin inserted into the end portion of the rod 212a is also used to substitute for the flange 222.

The resilient body 206a includes a conical spring or a compressible spring. The conical spring comprises a spiral coil including a first opening 224 and a second opening 226 located opposite the first opening. The cross-sectional area of the spiral coil includes a square, circular and the like cross-sections. The first opening 224 binds the rod of the cylinder and the second opening 226 expands outwardly on the sidewall of the piston 204 to create a frictional force between the outer edge of the spiral coil and the sidewall of the piston 204.

FIGS. 2B-2E show a schematic cross-sectional view of a slack adjuster 200a of first embodiment operation according to the present invention. In FIG. 2B, if the friction pad 216 is not worn, the clearance between the piston 204 and the disc is constant and the resilient body 206a is located at a first balance position 228a within the piston 204. In FIG. 2C, when starting to brake, the fluid pressure within the cylinder 202a is increased to move the piston 204 toward the disc of the braking system so that the resilient body 206a experiences a restoring force due to compression. When the braking process is finished, the fluid pressure of the cylinder 204 is decreased to move away from the disc of the braking system so that the restoring force of the resilient body 206a is used to pull back the piston, as shown in FIG. 2B.

The restoring force of the resilient body 206a is smaller than or equal to the friction force between the second portion 218 of the resilient body 206a and the sidewall of the piston 204. In other words, the friction force is overcome by the restoring force to move the resilient body 206a together with the piston 204 so that the resilient body 206a is always kept in the first balance position 228a. As a result, the clearance between the piston 204 and the disc is invariable.

In FIG. 2D, if the friction pad 216 has been worn down, the clearance between the piston 204 and the disc is increased. The resilient body 206a is positioned at the second balance position 230a. In FIG. 2E, when starting to brake, the piston 204 moves toward the disc such that the resilient body 206a exerts a restoring force. When stopping braking, the piston 204 moves the friction pad away from the disc surface and is drawn back by the restoring force, as shown in FIG. 2D.

The restoring force of the resilient body 206a is higher than the friction force between the second end portion of the resilient body 206a and the sidewall 221 of the piston 204. In other words, the friction force cannot overcome the restoring force. Therefore, a relative movement between the resilient body 206a and the piston 204 occurs so that the resilient body 206a slides from the first balance position 228a to the second balance position 230a. After the braking process is finished, the resilient body 206a positioned in the second balance position 230a removes away from the disc. Since the contact between the resilient body 206a and the piston 204 is changed such that a clearance between the piston 204 and the disc is in a predetermined position.

Second Embodiment

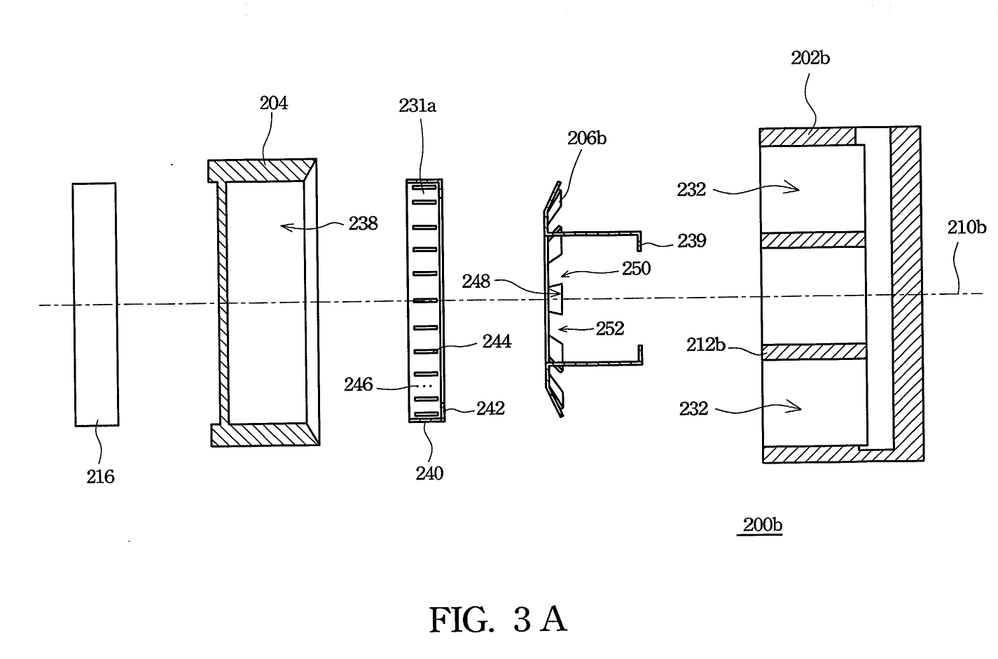

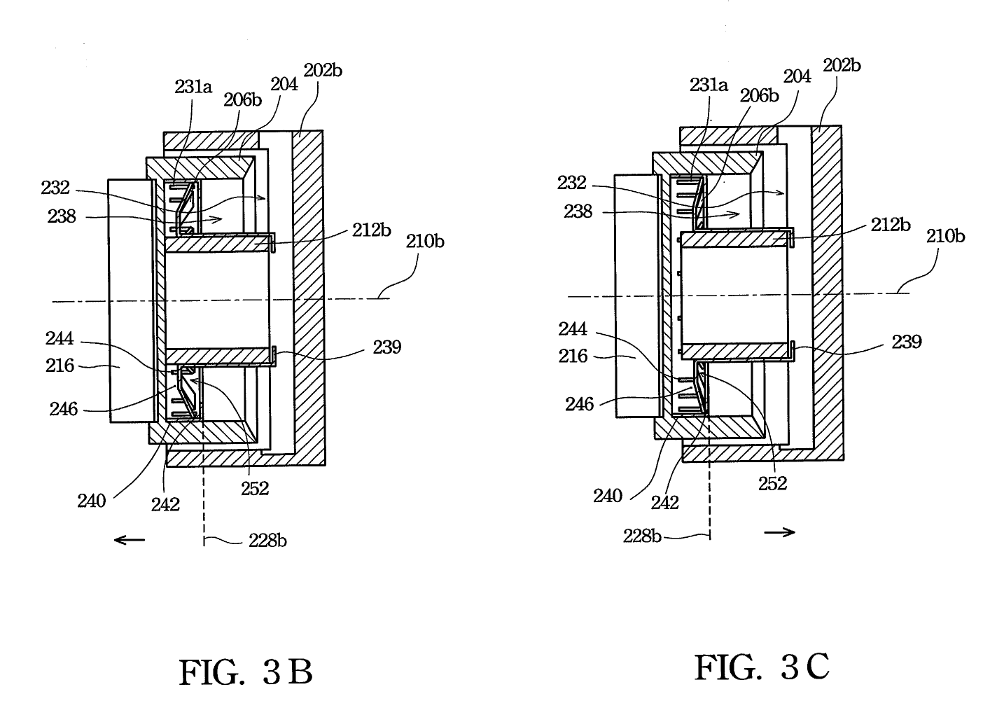

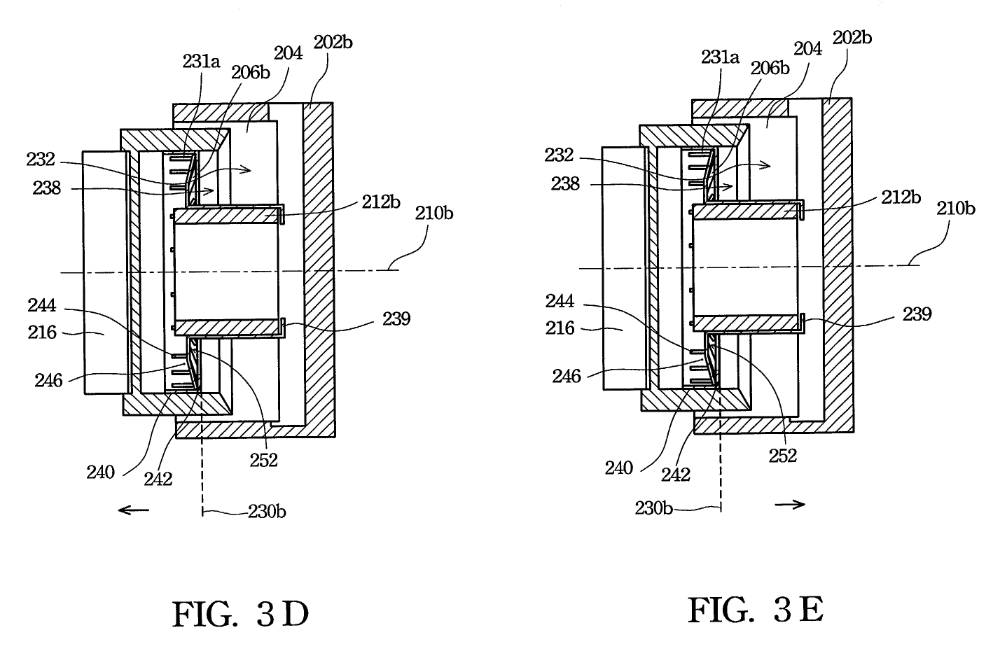

FIG. 3A shows a schematic cross-sectional view of a slack adjuster 200b of second embodiment according to the present invention. The slack adjuster 200b comprises a cylinder 202b, a piston 204, an expansion ring 208a, and a resilient body 206b. The cylinder 202b has a first cavity 232 which includes a rod 212b along an axial center. The piston 204 has a first sidewall 234 coupled with first cavity 232 of cylinder 202b so that piston 204 reciprocates in the first cavity 232, and the piston 204 has a second cavity 238 to receive the expansion ring 208a and the resilient body 206b.

The expansion ring 208a, hollow in shape, has a second sidewall 240 coupled with the second cavity 238 of piston 204 by a friction force, and a flange 242 is positioned at an end portion of expansion ring 208a. The resilient body 206a coupled with the rod 212b of cylinder 202b. The resilient body 206b has a first portion and a second portion wherein the first portion is mounted on the rod 212b of the cylinder 202b and the second portion resists the flange 242 of expansion ring 208a . Similarly, the piston 204 along the axial center 210b has a friction pad 216 to stop a disc of the braking system.

In the preferred embodiment of the present invention, the second sidewall 240 of the expansion ring 208a includes a plurality of slots 244 and a plurality of protruding portions 246 to adjust the contact friction. Specifically, due to the protruding portions 246 and the slots 244 on the second sidewall 240 of the expansion ring 208a, the expansion ring 208a is able to tightly or uniformly attach to the sidewall of the piston 204 to obtain a stable operation.

The resilient body 206b comprises a disc spring having a first opening 248 and a second opening 250 along the axial center 210b. A surface region positioned between first opening 248 and second opening 250 is used to generate a restoring force as the disc spring is applied to a force. The surface region further comprises a plurality of slots 252 to adjust the restoring force. Additionally, the first opening 248 of the disc spring has a hook portion along the surface region for mounting the disc spring on the cylinder 202b.

FIGS. 3B-3E show a schematic cross-sectional view of a slack adjuster 200b of second embodiment operation according to the present invention. In FIG. 3B, if the friction pad 216 has not been worn away, the clearance between the piston 204 and the disc is constant and the expansion ring 208a is located at a first balance position 228b within the piston 204. In FIG. 3C, when starting to brake, the fluid pressure within the cylinder 202b is increased to move the piston 204 toward the disc of the braking system so that the resilient body 206b experiences a restoring force due to compression. When the braking process is finished, the fluid pressure of the cylinder 202b is decreased to move away from the disc of the braking system so that the restoring force of the resilient body 206b is used to pull back the piston 204, as shown in FIG. 3B. Besides, after a brake process is completed and the fluid pressure within the cylinder 202 is decreased, the piston 204 is attracted backward not only by a negative pressure but by the restoring force of the disc spring to induce the expansion ring 208a.

The restoring force of the resilient body 206b is smaller than or equal to the friction force between the second sidewall 240 of the expansion ring 208a and the piston 204. In other words, the friction force is overcome by the restoring force to move the resilient body 206b together with the piston 204 so that the expansion ring 208a always is kept in the first balance position 228b. As a result, the clearance between the piston 204 and the disc is invariable.

In FIG. 3D, if the friction pad 216 has been worn down, the clearance between the piston 204 and the disc is increased. The expansion ring 208a is positioned at the second balance position 230b. In FIG. 3E, when starting to brake, the piston 204 moves towards the disc such that the resilient body 206b exerts a restoring force. When braking is finished, the piston 204 moves away from the disc and is drawn back by the restoring force, as shown in FIG. 3D.

The restoring force of the resilient body 206b is higher than the friction force between the second sidewall 240 of the expansion ring 208a and the piston 204. In other words, the friction force cannot overcome the restoring force. Therefore, a relative movement between the expansion ring 208a and the piston 204 occurs so that the expansion ring 208a slides from the first balance position 228b to the second balance position 230b. After the braking process is finished, the resilient body 206b positioned in the second balance position 230b can remove the expansion ring 208a and the piston 204 from the disc. Since the contact between the expansion ring 208a and the piston 204 is changed such that a clearance between the piston 204 and the disc is in a predetermined position.

Third Embodiment

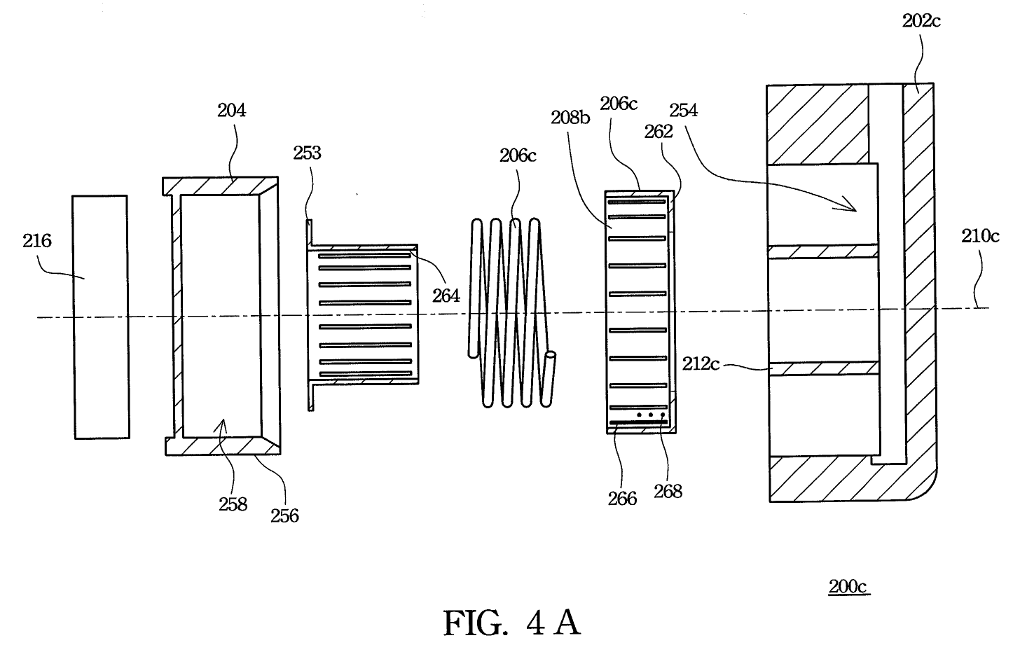

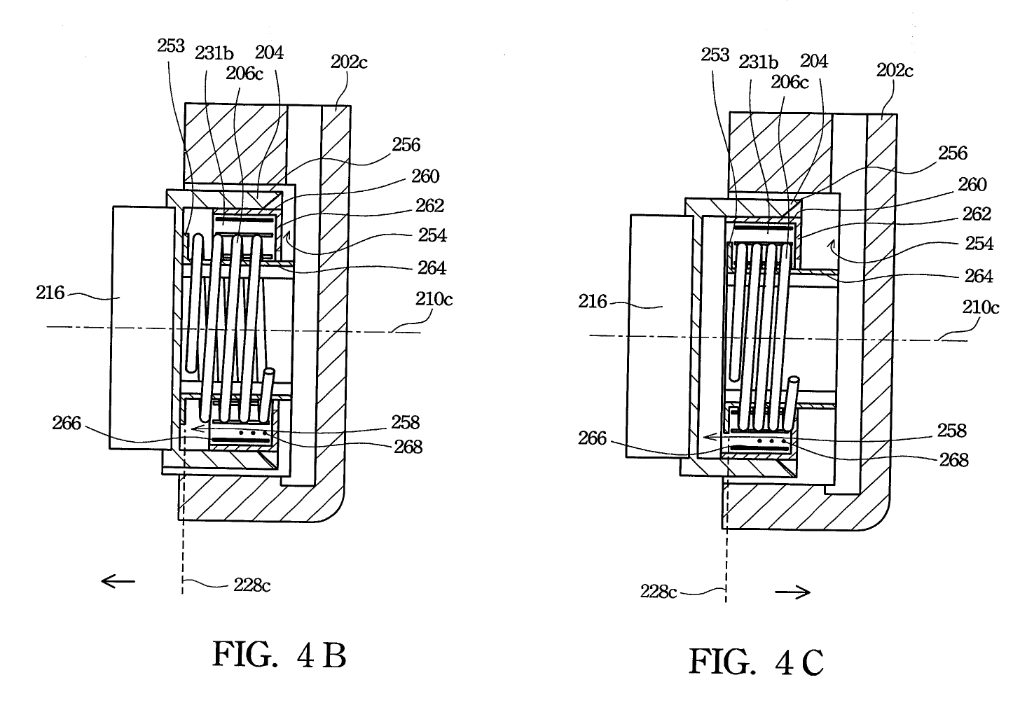

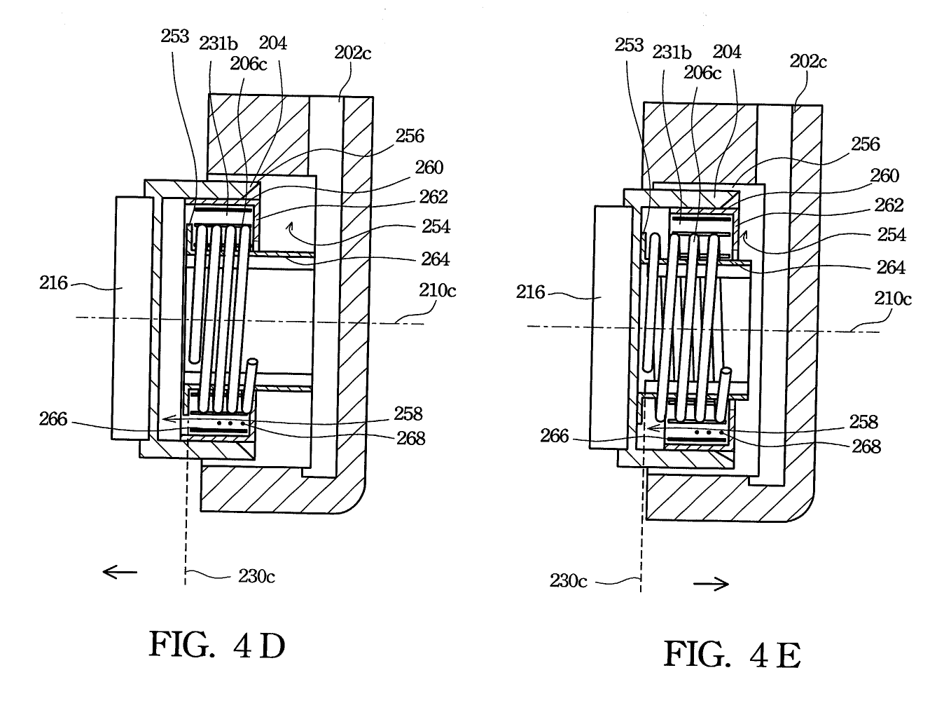

FIG. 4A shows a decomposed cross-sectional view of a slack adjuster 200c of third embodiment according to the present invention. The slack adjuster 200c comprises a cylinder 202c, a piston 204, an expansion ring 208b, a shrinkage ring 253, and a resilient body 206c. The cylinder 202c has a first cavity 254 which includes a rod 212c along an axial center 210c. The piston 204 has a first sidewall 256 coupled with the first cavity 256 of the cylinder 202c so that the piston 204 reciprocates in the first cavity 256, and the piston 204 has a second cavity 258 to receive the expansion ring 208b, shrinkage ring 253 and the resilient body 206c.

The expansion ring 208b, hollow in shape, has a second sidewall 260 to be mounted on the second cavity 258 of the piston 204. A first flange 262 is positioned at a first end portion of the expansion ring 208b. The shrinkage ring 253 has a third sidewall 264, the third sidewall 264 slid with the rod 212c of the cylinder 202c, and a second flange 259 is positioned at a second end portion of the shrinkage ring 253. The resilient body 206c is coupled with the rod 212c of the cylinder 202c. The resilient body 206c is confined between the first flange 262 of the expansion ring 208b and the second flange 259 of the shrinkage ring 253 along the axial center. Similarly, the piston 204 has a friction pad to stop a disc of the braking system.

In the preferred embodiment of the present invention, the second sidewall 260 of the expansion ring 208b includes a plurality of slots 266 and a plurality of protruding portions 268 friction sufficient to mount the expansion ring 208b on the second cavity 258 of the piston 204. The shrinkage ring 253 further comprises a plurality of slots and a plurality of protruding portions to adjust the friction force between the shrinkage ring 253 and the rod 212c of the cylinder 202c.

FIGS. 4B-4E show a schematic cross-sectional view of a slack adjuster 200c of third embodiment operation according to the present invention. In FIG. 4B, if the friction pad 216 has not been worn down, the clearance between the piston 204 and the disc is constant and the shrinkage ring 253 is located at a first balance position 228c within the piston 204. In FIG. 4C, when starting to brake, the fluid pressure within the cylinder 202c is increased to move the piston 204 toward the disc of the braking system so that the resilient body 206c gets a restoring force due to compression motion. When braking process is finished, the fluid pressure of the cylinder 202c is decreased to move away from the disc of the braking system so that the restoring force of the resilient body 206c is used to pull back the piston 204, as shown in FIG. 4B.

The restoring force of the resilient body 206c is smaller than or equal to the friction force between the third sidewall 264 of the shrinkage ring 253 and the rod 212c of the cylinder 202c. In other words, the friction force is overcome by the restoring force to move the resilient body 206c together with the piston 204 so that the shrinkage ring 253 always is kept in the first balance position 228c. As a result, the clearance between the piston and the disc is invariable.

In FIG. 4D, if the friction pad 216 has worn down, the clearance between the piston 204 and the disc is increased. The shrinkage ring 253 is positioned at the second balance position 230c. In FIG. 4E, when starting to brake, the piston 204 moves toward the disc so that the resilient body 206c acquires a restoring force. When stopping to brake, the piston 204 moves away from the disc and is drawn back by the restoring force, as shown in FIG. 4D.

The restoring force of the resilient body 206c is higher than the friction force between the third sidewall 264 of the shrinkage ring 253 and the rod 212c of the cylinder 202c. In other words, the friction force cannot overcome the restoring force. Therefore, a relative movement between the shrinkage ring 253 and the piston 204 occurs so that the shrinkage ring 253 slides from the first balance position 228c to the second balance position 230c. After the braking process is finished, the shrinkage ring 253 positioned in the second balance position 230c can remove the shrinkage ring 253 and the rod 212c from the disc. Since the contact between the shrinkage ring 253 and the rod 212c is changed such that a clearance between the piston 204 and the disc is in a predetermined position.

According to the above-mentioned, the slack adjuster uses a friction force among a piston, a resilient body and a cylinder, and a resilience of the resilient body. The piston automatically move backward in a predetermined position to ensure a proper clearance range between the friction pad and the disc. As a result, the contact between the friction pad and the disc is controllable to prevent wear, noise, shock and heat accumulation after a braking process is completed.

More significantly, the slack adjuster is able to self-adjust a balance position of the piston to acquire a predetermined clearance between a friction pad and a piston when the piston has been worn down due to a frictional motion. Complex manual modification of position is effectively omitted. Moreover, since a clearance between the friction pad and the disc can be obtained from computation or experimentation, the next stroke of the piston is not affected when the friction pad is far away from the disc, thus solving the problem of insufficient withdrawal of the piston. In addition, the slack adjuster has many advantages such as good manufacturing, assembly, safety, and compatibility.

As understood by a person skilled in the art, the foregoing preferred embodiments of the present invention are illustrations rather than limitations of the present invention. It is intended to cover various modifications and similar arrangements included within the spirit and scope of the appended claims, the scope of which should be accorded the broadest interpretation so as to encompass all such modifications and similar structure.

What is claimed is:

1. A slack adjuster for a braking system, said slack adjuster comprising:
a cylinder having a cavity, wherein the cavity a rod along a axial center and a protruding portion positioned on a surface region of said cavity;
a piston having a sidewall coupled with said cavity of said cylinder so that said piston reciprocates in said cavity of said cylinder; and
a resilient body having a first portion and a second portion, said first portion mounted on said rod of said cylinder, said second portion coupled with the sidewall of said piston by a friction force therebetween and held said protruding portion of said cylinder.

2. The slack adjuster of claim 1, wherein said resilient body has a restoring force due to a removal motion of said piston along said cavity of said cylinder and said restoring force is smaller than or equal to said friction force between said second portion of said resilient body and the sidewall of said piston so that said resilient body moves together with said piston.

3. The slack adjuster of claim 1, wherein said resilient body has a restoring force due to a removal motion of said piston along said cavity of said cylinder and said restoring force is higher than said friction force between said second portion of said resilient body and the sidewall of said piston so that said resilient body has a slide into said piston.

4. The slack adjuster of claim 1, wherein said resilient body comprises a conical spring or a compressible spring.

5. The slack adjuster of claim 4, wherein said conical spring has a spiral coil, said spiral coil including a first opening and a second opening along the axial center wherein said first opening binds up said rod and said second opening expands outwardly on the sidewall of the piston.

6. The slack adjuster of claim 5, wherein said conical spring further comprises a hook portion for mounting said conical spring on said cylinder.

7. The slack adjuster of claim 1, wherein said rod comprises a flange on a end portion thereon for resisting said first portion of said resilient body.

8. A slack adjuster for a braking system, said slack adjuster comprising:
a cylinder having a first cavity, wherein the first cavity includes a rod along an axial center;
a piston having a first sidewall coupled with said first cavity of said cylinder, wherein said piston reciprocates in said first cavity, said piston having a second cavity;
an expansion ring having a second sidewall coupled with said second cavity of said piston by a friction force, and a flange positioned at a end portion of said expansion ring; and
a resilient body coupled with said rod of said cylinder, said resilient body having a first portion and a second portion, said first portion being mounted on said rod of said cylinder and said second portion resisting said flange of said expansion ring.

9. The slack adjuster of claim 8, wherein said resilient body has a restoring force due to a removal motion of said piston along said first cavity of said cylinder and said restoring force is smaller than or equal to said friction force between said second sidewall of said expansion ring and said piston so that said expansion ring moves together with said piston.

10. The slack adjuster of claim 8, wherein said resilient body has a restoring force due to a removal motion of said piston along said first cavity of said cylinder and said restoring force is higher than said friction force between said second sidewall of said expansion ring and said piston so that said resilient body has a slide motion into said piston.

11. The slack adjuster of claim 8, wherein said second sidewall of said expansion ring further comprises a plurality of slots.

12. The slack adjuster of claim 8, wherein said second sidewall of said expansion ring further comprises a plurality of protruding portions.

13. The slack adjuster of claim 8, wherein said resilient body comprises a disc spring having a first opening and a second opening along the axial center, and a surface region is positioned between said first opening and said second opening for generating a restoring force as a force is applied to said disc spring.

14. The slack adjuster of claim 13, wherein said surface region further comprises a plurality of slots.

15. The slack adjuster of claim 14, wherein said surface region of said disc spring further comprises a hook portion for mounting said disc spring on said cylinder.

16. A slack adjuster for a braking system, said slack adjuster comprising:
a cylinder having a first cavity which includes a rod along an axial center;
a piston having a first sidewall coupled with said first cavity of said cylinder so that said piston reciprocates in said first cavity, and said piston having a second cavity;
an expansion ring having a second sidewall, said second sidewall mounted on said second cavity of said piston, and a first flange positioned at a first end portion of said expansion ring;
a shrinkage ring having a third sidewall, wherein said third sidewall slides with said rod of said cylinder, and a second flange is positioned at a second end portion of said shrinkage ring; and
a resilient body axially connected to said rod of said cylinder, said resilient body confined between said first flange of said expansion ring and said second flange of said shrinkage ring along the axial center.

17. The slack adjuster of claim 16, wherein said resilient body has a restoring force due to a removal motion of said piston along said first cavity of said cylinder and said restoring force is smaller than or equal to said friction force between said third sidewall of said shrinkage ring and said rod of said cylinder so that said shrinkage ring moves together with said rod of said cylinder.

18. The slack adjuster of claim 16, wherein said resilient body has a restoring force due to a removal motion of said piston along said first cavity of said cylinder and said restoring force is higher than said friction force between said third sidewall of said shrinkage ring and said rod of said cylinder so that said shrinkage ring has a slide motion into said rod of said cylinder.

19. The slack adjuster of claim 16, wherein said second sidewall of said expansion ring further comprises a plurality of slots.

20. The slack adjuster of claim 16, wherein said second sidewall of said expansion ring further comprises a plurality of protruding portions for generating a sufficient force between said expansion ring and said piston.

21. The slack adjuster of claim 16, wherein said third sidewall of shrinkage ring further comprises a plurality of slots.

22. The slack adjuster of claim 16, wherein said third sidewall of shrinkage ring further comprises a plurality of protruding portions.
